(19) United States
(12) Patent Application Publication
(10) Pub. No.: US 2025/0239826 A1
(43) Pub. Date: Jul. 24, 2025

(54) Induction Soldering Method for Terminating Terminals to FFC/PFC Cables to Various Terminals

(71) Applicant: TE Connectivity Solutions GmbH, Schaffhausen (CH)

(72) Inventors: Christopher Ryan Raybold, Middletown, PA (US); David Bruce Sarraf, Middletown, PA (US)

(73) Assignee: TE Connectivity Solutions GmbH, Schaffhausen (CH)

(21) Appl. No.: 18/419,815

(22) Filed: Jan. 23, 2024

(51) Int. Cl. H01R 43/02; B23K 13/01; H05B 6/10

(52) U.S. Cl. CPC H01R 43/0263; B23K 13/01; H01R 43/0242; H05B 6/101

(57) ABSTRACT

A method of attaching a flat flexible cable (FFC) to a plurality of terminals of an electrical connector includes a step of arranging a plurality of terminals within a connector housing, with each terminal defining a weld area adapted to be electrically connected to a conductor of the FFC. The FFC is then positioned proximate the connector housing such that the weld areas of each terminal are arranged directly adjacent a respective one of a plurality of exposed conductors of the FFC. At least the weld areas of the plurality of terminals are heated with an inductive heating source for electrically connecting the plurality of conductors of the FFC to the plurality of terminals.

### FIELD OF THE INVENTION

The present disclosure relates to electrical connectors, and more particularly, to systems and methods for electrically connecting flat flexible cables to conductive terminals of electrical connectors.

### BACKGROUND

As understood by those skilled in the art, flat flexible cables (FFCs) or printed flexible cables (PFCs) are electrical components consisting of at least one conductor (e.g., a metallic foil conductor) embedded within a thin, flexible strip of insulation. Flat flexible cables are gaining popularity across many industries due to advantages provided over their traditional “round wire” counter parts. Specifically, in addition to having a lower profile and lighter weight, FFCs enable the implementation of large circuit pathways with significantly greater ease compared to a round wire-based architectures. As a result, FFCs are being implemented into many complex and/or high-volume applications, including wiring harnesses such as those used in automotive manufacturing.

A critical obstacle preventing the implementation of FFCs into these applications includes the need to develop quick, robust, and low resistance termination techniques which enable the FFCs to be mating with various components. One particular challenge includes reliably and efficiently terminating the fragile conductors of the FFC to a conductive terminal of a connector. Existing methods include the use of laser or resistance heating techniques. Laser heating, however, is often less reliable and cumbersome to implement. Likewise, resistance heating has proven relatively difficult to reliably implement, further it is time consuming and requires regular maintenance (e.g., the replacement of heating tips). Current methods are also not suitable for mass termination and/or automation, which the industry desires.

Accordingly, improved methods for terminating FFC assemblies are desired.

### SUMMARY

In one embodiment of the present disclosure, a method of attaching a flat flexible cable (FFC) to a plurality of terminals of an electrical connector includes a step of arranging a plurality of terminals within a connector housing, with each terminal defining a weld area adapted to be electrically connected to a conductor of the FFC. The FFC is positioned proximate the connector housing such that the weld areas of each terminal are arranged directly adjacent a respective one of a plurality of exposed conductors of the FFC. At least the weld areas of the plurality of terminals are heated with an inductive heating source for electrically connecting the plurality of conductors of the FFC to the plurality of terminals.

### BRIEF DESCRIPTION OF THE DRAWINGS

The invention will now be described by way of example with reference to the accompanying Figures, of which:

FIG. 1 is side perspective view of an FFC connector assembly useful for describing embodiments of the present disclosure in a mated state;

FIG. 2 is a cross-sectional view of the connector assembly of FIG. 1 in an initial alignment state;

FIG. 3 is a cross-section view of the connector assembly of FIG. 1 in the mated state;

FIG. 4 is a bottom perspective view of a cable subassembly including an FFC and a cable stiffening element installed thereon;

FIG. 5 is a front view of the cable subassembly of FIG. 4;

FIG. 6 is a bottom perspective view of a terminal used in the connector assembly of the preceding figures;

FIG. 7 is a bottom view of the terminal of FIG. 6;

FIG. 8 is a side view of the terminal of FIG. 7;

FIG. 9 is a partial side view of another terminal which may be utilized in embodiments of the present disclosure;

FIG. 10 is a top view of a plug of the connector assembly with a plurality of terminals inserted therein;

FIG. 11 is a bottom view of the plug of FIG. 10;

FIG. 12 is a bottom perspective view of the cable subassembly of FIGS. 4 and 5 further including solder applied across exposed conductors of the FFC;

FIG. 13 is a side perspective view of a cable assembly including the cable subassembly of FIGS. 4 and 4 in an initial mating position with the plug of FIGS. 10 and 11;

FIG. 14 is a bottom view of the cable assembly of FIG. 13 illustrating a soldering operation or method for electrically connecting the FFC to the terminals of the connector;

FIG. 15 is a side view illustrating a soldering operation performed by a system according to embodiments of the present disclosure;

FIG. 16 is a diagram of an exemplary system useful for performing the soldering operations described herein; and

FIG. 17 is a cross-sectional view of a connector according to another embodiment of the present disclosure utilizing graphite fingers to improve induction soldering of its terminals.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

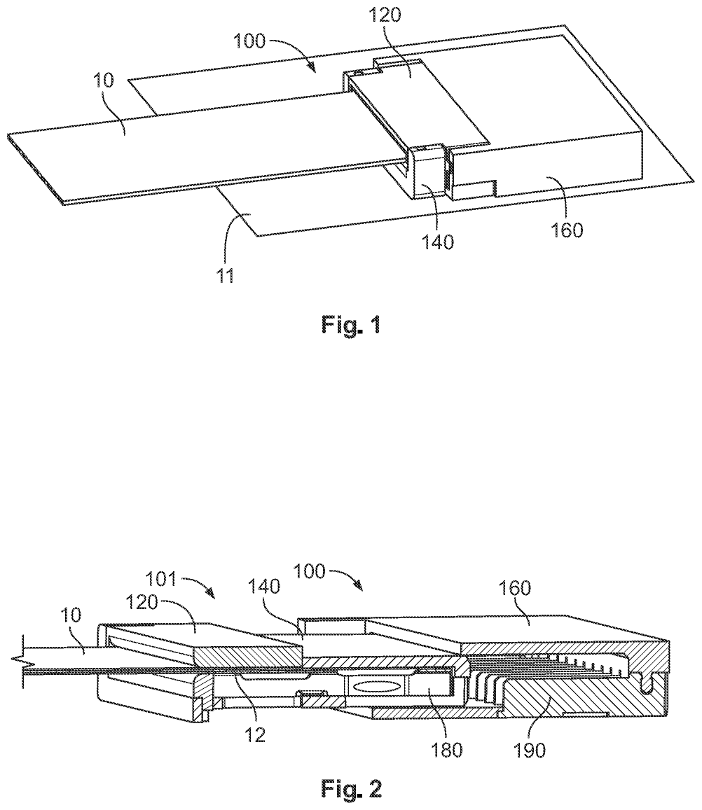

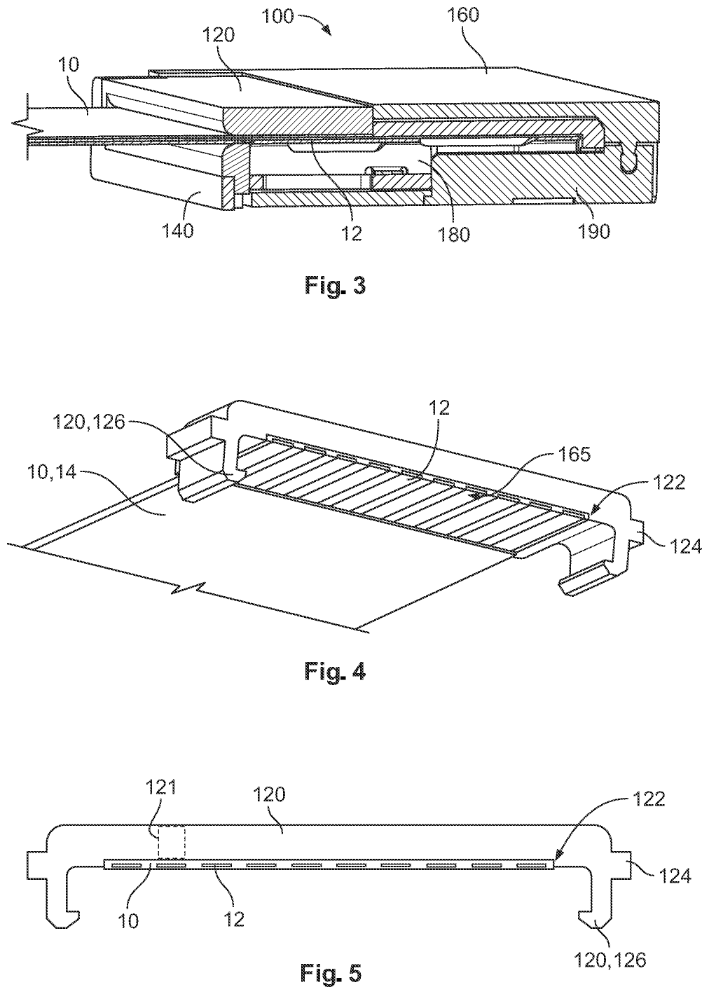

Referring to FIGS. 1-3, an exemplary FFC connector assembly 100 useful for describing termination methods according to embodiments of the present disclosure is shown. The connector assembly 100 includes a flat flexible cable (FFC) 10, a cable stiffening element or cable stiffener 120, a plug 140 and a header 160. The assembly 100 is adapted to electrically connect the FFC 10 to a substrate 11, such as a printed circuit board (PCB). FIGS. 1 and 3 illustrate the connector assembly 100 in fully mated state wherein a cable assembly 101, including the FFC 10, the stiffening element 120 and the plug 140, is mated to the header 160. In FIG. 2, the assembly 100 is in an initial alignment or partially mated position, wherein the stiffening element 120 and the plug 140 have not been mated to, or electrically engaged with, the header 160. As illustrated, the cable assembly 101 is inserted into a front opening of the header 160. In this way, the assembly 100 comprises a so-called “front load” connector system.

As further shown in FIG. 2, a plurality of conductive terminals 180 are held within the plug 140, and are electrically connected to a corresponding plurality of conductors 12 of the FFC 10 via, for example, a soldering process according to embodiments of the present disclosure. Each terminal 180 is further connectable to a respective one of a plurality of conductive header tabs or contacts 190 arranged on or within the header 160 as the plug 140 is inserted therein, as shown in FIG. 3. Ends of each header tab 190 are exposed through a bottom of the header 160 such that they may be electrically connected to the substrate or PCB 11 (e.g., via soldering or welding to conductive traces or pads formed thereon).

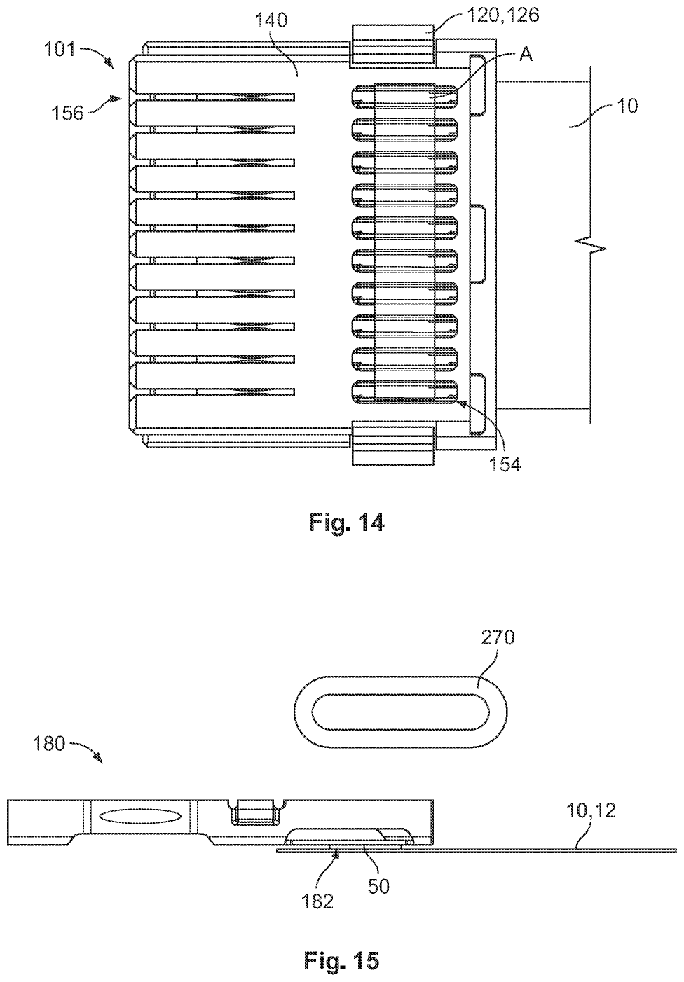

Referring now to FIGS. 4 and 5, the cable stiffener or stiffening element 120 is adapted to structurally support the FFC 10 as well as to securely fasten it to the plug 140. The stiffening element 120 defines a slotted opening 122 sized to receive the FFC 10 therethrough, a pair of guide protrusions 124, and a pair of latching arms 126. In one embodiment, the FFC 10 is fixed to the stiffening element (e.g., with an adhesive applied therebetween) in an initial step of a termination or assembly process. The guide protrusions 124 and the latching arms 126 are arranged on either lateral side of the stiffening element 120. The guide protrusions 124 are adapted to guide the cable assembly as it is mated with the header 160. The latching arms 126 are adapted to secure or affix the cable stiffening element 120 to the plug 140 as shown in FIGS. 13 and 14. With reference to FIG. 5, the stiffening element 120 may also include weld windows 121 (one exemplary window illustrated) formed therethrough in order to facilitate welding or soldering of the FFC 10 and the terminals 180 from a top side of the cable assembly 101.

Still referring to FIGS. 4 and 5, the conductors 12 of the exemplary FFC 10 are embedded within an insulating material 14. The conductors 12 may comprise metallic sheet or foil, such as copper foil, by way of example only, patterned in any desirable configuration. The insulating material 14, such as a polymer insulating material, may be applied to either side of the conductors 12 via an adhesive, resulting in an embedded conductor arrangement. The insulation material 14 may be selectively removed, or not initially applied, in desired areas for exposing the conductors 12, such as in a window 165 defined on an underside of the exemplary illustrated FFC 10. The exposed portion of each of the conductors 12 is then connected (e.g., soldered) to a respective terminal 180 held within the plug 140, as set forth in greater detail herein.

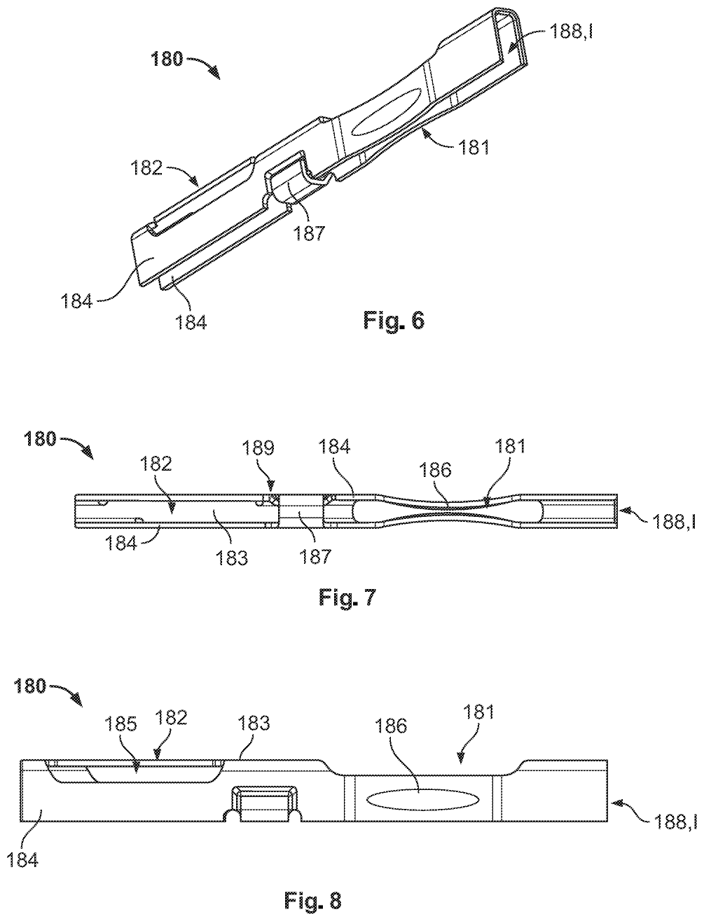

FIGS. 6-8 illustrate the exemplary terminal 180 in greater detail. The terminal 180 defines a central slot or slotted opening adapted to receive the header contact 190 slidably therein in an insertion direction I. The opening includes a front end or front opening 188 and a slotted contact area 181 in communication therewith. The terminal 180 further defines a weld area 182 adapted to be electrically connected to the exposed conductor 12 of the FFC 10 via welding or soldering. More specifically, the terminal 180 may comprises a generally inverted U-shaped cross-section including a top wall 183 and two generally parallel side walls 184 (or spring elements) extending perpendicularly from the top wall. The weld area 182 comprises a generally planar or flattened surface defined on the top wall 183. As shown in FIG. 8, an area directly under the weld area 182 defines a void space 185.

In the exemplary embodiment, one of the side walls 184 defines an integral brace or support 187 extending across the central opening and engaging the other one of the side walls 184. More specifically, the brace 187 may be bent across the slotted opening or contact area 181 defined between the side walls 184 on a bottom side of the terminal 180 opposite the top wall 183. The brace 187 may engage with, or be received by, a corresponding depression 189 formed in the other one of the side walls 184 such that its free end opposes the sidewall 184 in a direction perpendicular to a longitudinal axis of the contact area 181. In this way, the brace 187 is adapted to prevent excess spreading or opening of the slotted contact area 181 as the header contact 190 is inserted therein. This ensures sufficient and consistent electrical contact force between the terminal 180 and the header contact 190.

As can be visualized from the figures, the terminal 180 may be formed by a combination of sheet metal forming operations, such as stamping and bending. Stamping the area ultimately defining the side walls 184 adjacent the weld area 182 is used to effectively widen the weld area. Likewise, stamping the area corresponding to the top wall 183 is used to form the slotted contact area 181. Each of the side walls 184 may be bent or curved inwardly toward a central axis center of the terminal in the contact area 181 in order to assert adequate elastic tension or normal force on an inserted header tab 190. In some embodiments, the side walls 184 define inwardly facing, opposing raised contact protrusions 186 adapted to provide further engagement force on the header tab 190. In any embodiment, the terminal 180 and contact area 181 are adapted to generate sufficient normal force to be used effectively with tin or silver plating on a mating terminal. In still other embodiments, soldering or welding may also be used to connect the terminals 180 to the corresponding FFC conductors 12 without departing from the scope of the present disclosure. It should be understood that the separation between the side walls 184 ensures that no heat stress relaxation occurs during welding or soldering operations performed on the terminal 180.

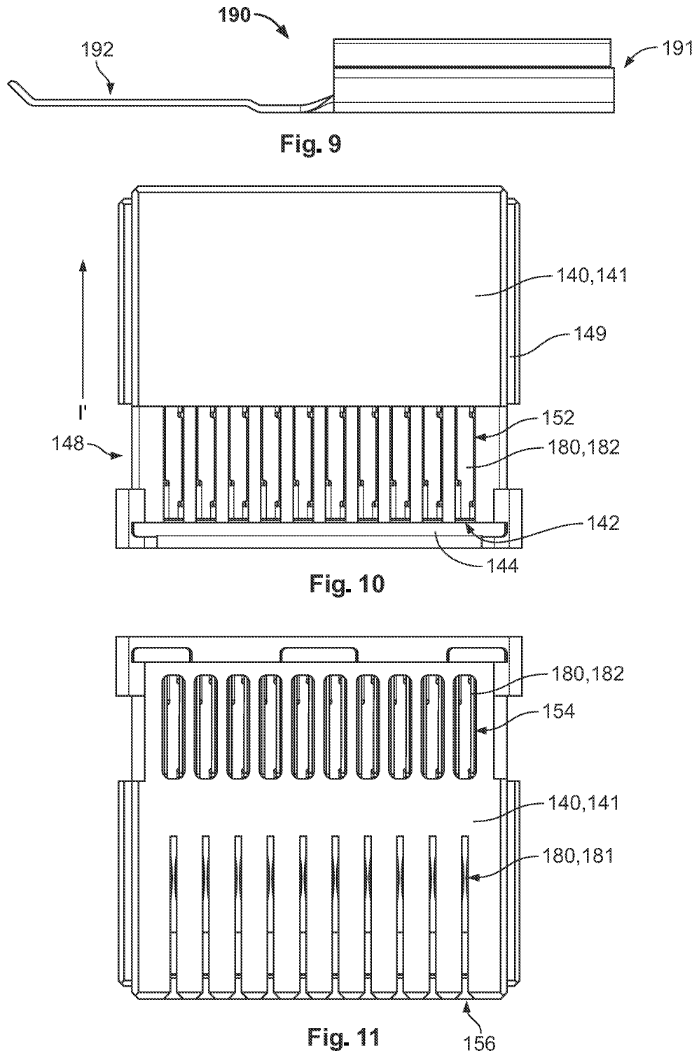

FIG. 9 illustrates another terminal 190 which may be utilized in plug or connector assemblies according to embodiments of the present disclosure. As shown, the terminal 190 includes a flattened weld or solder area 192 formed proximate a first end thereof, and a contact area 191 on a second end thereof (e.g., a female contact area adapted to receive a pin terminal). It should be understood that embodiments of the present disclosure are not limited to the two types of terminals illustrated in FIGS. 6-9

FIGS. 10 and 11 illustrate the plug 140 with the exemplary terminals 180 inserted therein. Specifically, as shown in FIG. 10, the plug 140 includes a plug body 141 defining a plurality of terminal openings 142. The terminals 180 are inserted into the openings 142 formed in a rear of the plug body in an insertion direction I′. Once the terminals 180 have been inserted, a slidable cover 144 may be translated from an open position (not shown) to the illustrated closed position, closing the openings 142 and fixing the terminals within the body 141. The plug body 141 is adapted to position each of the weld areas 182 of the terminals 180 on the same plane extending in the lateral direction.

The plug body 141 further defines elongated aligning protrusions or guides 149 formed on each lateral side thereof. The guides 149 are adapted to align the plug 140 relative to the header 160 and guide its insertion therein in the insertion direction (see FIGS. 1-3). The guides 149 also serve to align the plug body 141 and the header 160 in the mated state. The plug body 141 further defines latch recesses 148 formed on each lateral side thereof. The recesses 148 are adapted to receive, and securely engage with, the latching arms 126 of the stiffening element 120 for fixing the stiffening element 120 (and FFC 10) to the plug 140. In the fixed or latched position, the stiffening element 120 is adapted to hold or position the conductors 12 of the FFC 10 in contact with the terminals 180 (e.g., the weld areas 182 thereof).

A top wall of the plug body 141 shown in FIG. 10 defines weld tab openings 152 through which the weld areas 182 of the terminals 180 are exposed on the cable-side of the plug 140. As shown in FIG. 11, a bottom side of the plug 140 defines a plurality of windows 154 through which the underside of the weld areas 182 of the terminals 180 are exposed. The weld areas 182 may be heated through the windows 154 to, for example, weld or solder the terminals 180 to the conductors 12 of the FFC 10. The plug body 141 further includes a plurality of slots 156 formed through a bottom wall thereof and extending in a direction opposite the insertion direction I′ from a front end of the plug 140. The slots 156 are adapted (e.g., sized, shaped and located) to slidably receive the header contacts 190 therethrough during mating of the plug 140 and the header 160.

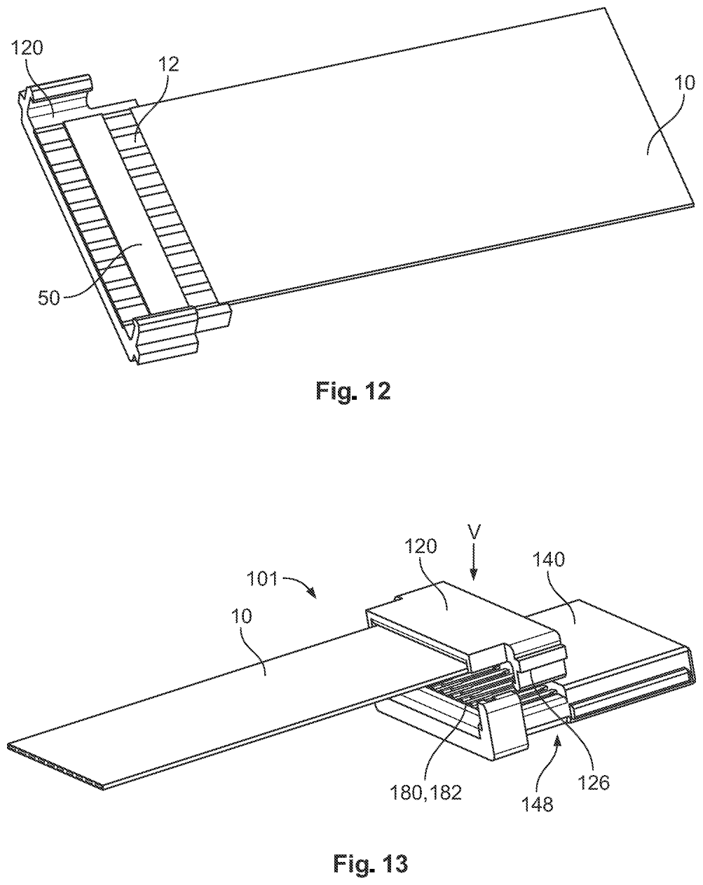

FIG. 12 provides a bottom perspective view of the cable subassembly in an intermediate step of a termination process according to an embodiment of the present disclosure. Specifically, after the cable stiffening element 120 has been attached to the FFC 10 (e.g., glued thereto via an adhesive, as shown), solder 50 is applied over the exposed conductors 12 of the FFC 10. The solder 50 may take the form of a solder foil or a solder paste (each with or without flux, e.g., a pre-fluxed foil or paste, or a foil or paste with a separate dispensed flux). In other embodiments, the FFC 10 may be provided with solder pre-applied, such as in the form of solder balls or solder pads.

In one particularly advantageous embodiment, the solder 50 is applied continuously and uniformly from one lateral side of the FFC 10 to the other, or from an outer exposed conductor 12 of the FFC 10 to an outer exposed conductor on the opposite side of the FFC. This arrangement simplifies the solder application process (e.g., either a single solder foil strip or a single deposition of solder paste) compared to embodiments which deposit solder only on the exposed conductors. As will set forth in greater detail herein, during a soldering operation, the solder process according to embodiments of the present disclosure is adapted to wick the solder from between the conductors 12 if the FFC 10, and from between corresponding terminals (e.g., the terminals 180 to be welded thereto.

Referring now to FIG. 13, a process for constructing the cable assembly 101 of the connector assembly 100 is provided. As shown in FIG. 13, with the cable stiffening element 120 fixed to the FFC 10 (e.g., via adhesive), the FFC and stiffening element are fitted to the plug 140. Specifically, from a separated position, biasing the stiffening element 120 in a downward direction V engages the latching arms 126 with the recesses 148 of the plug body 141 in a snap-fit manner. As a result, the exposed conductors 12 of the FFC 10 are positioned opposed to or directly adjacent (e.g., abutting) the weld areas 182 of the terminals 180. As shown in FIG. 14, from the underside of the plug 140, the conductors 12 and terminals 180 are heated through the windows 154 by an inductive heating element. In one embodiment, this target heating area A has a length of at least 3 mm in an axial direction of each terminal 180 and/or conductor 12.

With reference to FIG. 15, the terminal 180 and FFC 10 are shown during a soldering operation. Of note, the connector plug 140 has been removed for the sake of clarity, and the terminal and cable have been inverted from their orientations as described above. Melting of the solder 50 arranged between the conductors 12 of the FFC and the weld area 182 of each terminal 180 is achieved via at least one inductive heating coil or induction coil 270. The exemplary coil 270 is arranged on a side of the terminal 180 opposite the FFC 10 (i.e., on a bottom side of the plug or the terminal, as shown in FIG. 14). The melted solder 50 transfers heat to the conductors 12 of the FFC 10 to create a stable fully wetted solder joint. For thicker conductors and/or unique terminal geometries, a second induction coil 270 may be arranged on the other side of the terminal 180 to heat the conductors as needed to avoid overheating the terminal. Surface tension and the wicking action of the solder 50 pulls the solder from between the terminals 180 and the conductors 12 and into each joint space. Further, during soldering, at least one of the plug 140 or the FFC 10 may be vibrated to promote wicking of the solder from between the terminals 180 and into the joint space. After a soldering cycle is complete, cool air could be blown to further ensure that the terminal is not heated to the point where stress relaxation occurs. In other embodiments, cool air could be blown continuously, even during soldering operations to ensure a front portion of the connector stays relatively cool.

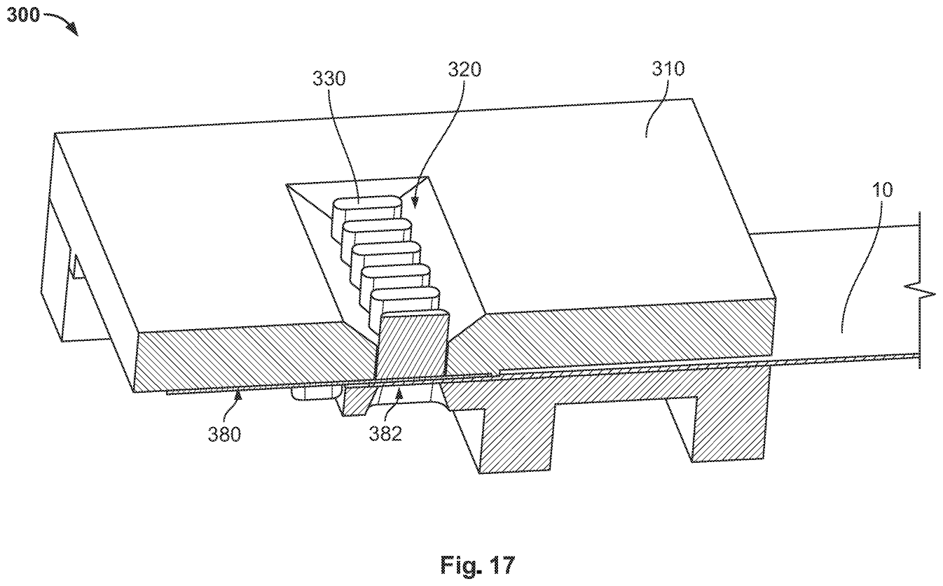

Referring to FIG. 17, in some embodiments, depending on the terminal geometry, graphite fingers may be used to direct or concentrate heat where needed during inductive soldering operations of the FFC 10. In the exemplary simplified embodiment, a connector 300 having a cover or housing 310 formed with an access opening 320 is shown. The access opening 320 may expose weld areas 382 of a plurality of terminals 380, as described above with the previous embodiments. As would be understood by one of ordinary skill in the art, induction heating is caused by circulating currents within a workpiece. Graphite requires orders of magnitude less current than, for example, copper, in order the achieve the same heating effect. For this reason, utilizing graphite fingers 330 positioned over the weld areas 382 of the terminals 380 may increase soldering efficiency and improve the targeting of areas to be heated. It should be understood that the connector 300 of FIG. 17 is a simplified representation in order to illustrate the application of the graphite fingers 330. It should be understood that many other variations may be made to the illustrated embodiment, for example, the number of openings 320 exposing the terminals 380 and/or FFC conductors may be varied (e.g., there may be one such opening for each weld area 382 or each terminal 380. Likewise, while a plurality of graphite fingers 330 are shown, a single graphite element may be inserted into the opening 320. The graphite fingers 330 may also be present on either side of the connector 300, or used in any of the above-described connectors without departing from the scope of the present disclosure.

While the above embodiments of the present disclosure describe the use of inductive soldering techniques to join FFCs to terminals, it should be understood that other forms of soldering may be used with the terminals described herein. For example, resistance soldering techniques or brazing may be utilized without departing from the present disclosure. As would be understood by one of ordinary skill in the art, this technique would require access to each side of the joint, as well as the application of a meltable joining alloy between the elements to be joined (i.e., the terminals and the FFC conductors). Similarly, other techniques like laser soldering (e.g., so-called “BLUE” laser soldering) may offer distinct advantages in speed and accuracy over other soldering techniques, and typically results in a very small spot size and low solder usage.

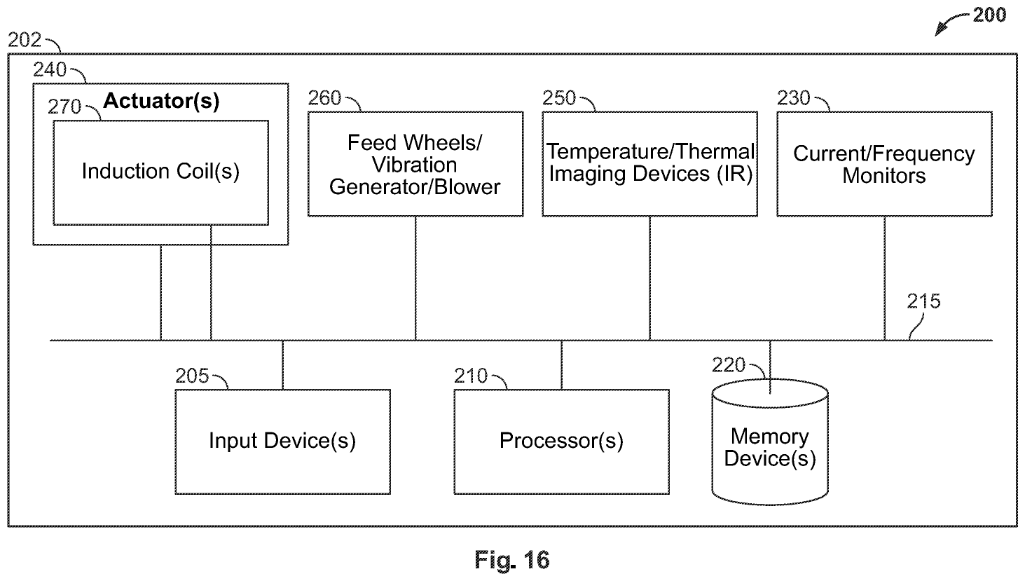

Soldering methods according to embodiments of the present disclosure may be carried out wholly or in part by one or more automated control systems implementing and/or controlling a soldering system or machine, as well as additional hardware and software features. For example, referring generally to FIG. 16, an exemplary control system 200 of a soldering system or machine 202 useful for performing the operations of the embodiments of the present disclosure is shown. The control system 200 may be under fully automated control, or fully or partially controlled via one or more user input devices 205 (e.g., touch screen/buttons/keyboards, etc.). The control system 200 includes at least one processor 210, such as a digital microprocessor responsive to instructions stored on a memory device 220 for performing the methods or operations described herein. The processor 210 is operatively coupled to the induction coil 270, and/or to a power supply thereof for selectively powering the coil under voltage and/or current control. The system 200 may further include a current and/or frequency monitor or sensor 230, which may be operative with the processor 210 to monitor and/or control the frequency and current in or through the induction coil 270.

The system 200, and more specifically the processor 210, may control the operation of feed wheels, vibration generator and/or blowers 260 of the machine 202 for selectively feeding the cable through the machine, vibrating the cable and connector assembly during soldering, and cooling the joint. Likewise, the control system 200 may comprise one or more actuators 240 (e.g., a linear actuator) operatively attached to the induction coil 270 for selectively moving the coil relative to the connector assembly being soldered. In one embodiment, the one or more actuators 240 may be multi-directional, having the ability to vary not only the longitudinal position of the induction coil 270 along a length of a connector assembly, but also the radial or lateral distance between the connector assembly and the induction coil, further promoting the ability to accurately control the generation of heat in predetermined areas of the assembly.

The control system 200 further comprises a temperature sensing device and/or imaging device, such as a thermal imaging device, and more specifically an infrared (IR) temperature sensor and/or camera 250, by way of example only. In other embodiments, the control system 200 may comprise separate temperature sensing devices and imaging devices. Further, the imaging device 250 may be optical, such as a digital camera or video capturing device without departing from the scope of the present disclosure. The thermal imaging device 250 may be mounted to the induction coil 270, or to another portion of the machine 202 suitable for achieving desired operation. As shown, each of the components of the control system 200 and/or the machine 202 may communicate over a shared power/data bus 215.

The control system 200, including the processor 210 operative with associated instructions pre-stored on the memory device 220, enables several additional modes of operations to those described above with respect to the proceeding figures. By way of example, using the current and/or frequency monitor 230, as well as predetermined values stored on the memory device 220, the processor 210 is operative to determine or estimate a characteristic, such as a size of the FFC conductors and/or the terminals, and automatically adjust various operating parameters according to this determination. The system 200 may vary heating times, periodic cycling parameters, frequency, voltage and/or current associated with the operation of the induction coil 270 according to a detected characteristic for achieving optimal operation. These parameters may be pre-stored in the memory device 220 such that, upon a determination by the processor 210 as to the relevant characteristics of the connector and/or FFC arrangement, the function of the coil 270 may be automatically controlled without the need for further user input.

According to embodiments, power is supplied to the induction coil 270 for a specified amount of time based on the application. The frequency of the induction coil 270 may be varied to control the depth of heating, for example, higher frequency allows the depth of the induction heating to be controlled such that the penetration of the induction heating is shallow. In contrast, a lower frequency allows induction heating to more deeply penetrate into the elements to be soldered.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A method of attaching a flat flexible cable (FFC) to a plurality of terminals, comprising:
arranging a plurality of terminals within a connector housing, each terminal defining a weld area adapted to be electrically connected to a conductor of the FFC;
positioning the FFC proximate the connector housing such that the weld area of each terminal is arranged directly adjacent a respective one of a plurality of exposed conductors of the FFC; and
heating at least the weld area of each of the plurality of terminals with an inductive heating source for electrically connecting the plurality of conductors of the FFC to the plurality of terminals.

2. The method of claim 1, further comprising the step of, prior to positioning the FFC proximate the connector housing, fitting a stiffening element to a side of the FFC opposite the plurality of exposed conductors.

3. The method of claim 2, further comprising the step of, prior to step of heating, securing the stiffening element onto the connector housing such that the exposed conductors of the FFC are aligned with the weld areas of the terminals.

4. The method of claim 3, wherein the connector housing includes:
a plurality of first openings defined on a first side thereof and exposing the weld area of each of the terminals; and
a plurality of second openings defined on a second side thereof and exposing an underside of each weld area.

5. The method of claim 4, wherein the inductive heating source is arranged proximate the second side of the connector housing.

6. The method of claim 5, wherein the step of heating is further performed by a second inductive heating source arranged proximate the first side of the connector housing.

7. The method of claim 6, wherein the stiffening element includes a plurality of stiffening element openings formed therethrough and adapted to be aligned with each of the plurality of conductors of the FFC, the second inductive heating source heating the weld areas of the plurality of terminals through the plurality of stiffening element openings.

8. The method of claim 4, further comprising, a plurality of third openings defined in the second side of the housing and exposing a contact area of each of the terminals for electrically engaging with a respective one of a plurality of contacts of a complementary mating connector.

9. The method of claim 1, wherein at least one of one of solder balls or solder pads are formed on the exposed conductors of the FFC.

10. The method of claim 1, further comprising the step of, prior to the step of positioning the FFC, applying solder to the exposed conductors of the FFC.

11. The method of claim 10, wherein the step of applying solder includes applying a single continuous layer of solder over the plurality of exposed conductors.

12. The method of claim 11, wherein the step of heating is controlled such that the solder is pulled from between adjacent ones of the plurality of exposed conductors and the plurality of terminals.

13. The method of claim 11, wherein the step of applying the single continuous layer of solder includes applying a solder foil across the plurality of exposed conductors.

14. The method of claim 11, wherein the step of applying the single continuous layer of solder includes applying a solder paste across the plurality of exposed conductors.

15. The method of claim 1, further comprising the step of blowing air onto at least one of the plurality of terminals or the connector housing.

16. The method as recited in claim 1, further comprising the steps of:
detecting a temperature of the weld area of at least one of the plurality of terminals; and
controlling at least one of a duration, current, or frequency of operation of an induction coil of the inductive heating source.

17. A method of attaching a flat flexible cable (FFC) to a plurality of terminals of an electrical connector, comprising:
applying a solder across at least one of the plurality of terminals or a plurality of exposed conductors of the FFC;
fitting a stiffening element onto the FFC;
fixing the stiffening element onto a housing of the electrical connector such that the plurality of exposed conductors of the FFC abut the plurality of terminals;
heating at least a portion of the plurality of terminals with an inductive heating source to electrically connect the plurality of exposed conductors of the FFC to the plurality of terminals via the solder.

18. The method of claim 17, wherein the connector housing includes:
a plurality of first openings defined on a first side thereof and exposing a weld area of each of the plurality of terminals; and
a plurality of second openings defined on a second side thereof and exposing an underside of each weld area.

19. The method of claim 17, wherein the step of applying the solder includes applying a single continuous layer of solder over the plurality of terminals or the plurality of exposed conductors.

20. The method of claim 19, further comprising the step of, during the step of heating, vibrating at least one of the FFC or the electrical connector to facilitate removal of the solder from between adjacent ones of the plurality of exposed conductors and the plurality of terminals.
